(19) United States
(12) Patent Application Publication
(10) Pub. No.: US 2018/0147430 A1
(43) Pub. Date: May 31, 2018

(54) GAS GENERATOR FIRE SUPPRESSION SYSTEM

(71) Applicant: Kidde Graviner Limited, Berkshire (GB)

(72) Inventors: Adam Chattaway, Windsor (GB); Terry Simpson, Wake Forest, NC (US)

(21) Appl. No.: 15/827,033

(22) Filed: Nov. 30, 2017

(30) Foreign Application Priority Data
Nov. 30, 2016 (GB) 1620339.0

(51) Int. Cl. A62C 5/00; A62C 35/13; A62C 35/02

(52) U.S. Cl. CPC A62C 5/006; A62C 3/002; A62C 35/023; A62C 35/13

(57) ABSTRACT

A solid propellant gas generator fire suppression device 6 is disclosed comprising: a solid propellant material for generating a first fire suppression gas when combusted; an ignitor 10 for igniting the solid propellant material so as to generate said gas; an exhaust 12 for said gas; and an odorizer material arranged within the gas generator so that when the ignitor 10 is activated the odorizer material, or an odorous product thereof, exits the gas generator 6 through the exhaust 12.

### FOREIGN PRIORITY

This application claims priority to United Kingdom (GB) Application No. 1620339.0 filed Nov. 30, 2016, the entire contents of which is incorporated herein by reference.

### FIELD OF THE INVENTION

The present invention relates generally to fire suppression systems and in particular to a system comprising a solid propellant gas generator for discharging a fire suppressant into an area to be protected from fire.

### BACKGROUND

It is known to discharge gases into an area in order to protect that area from fire, e.g. upon detection of heat or smoke. For example, Halon 1301 has conventionally been used as a fire suppressant for protecting aircraft cargo compartments. Halon 1301 is stored under pressure as a liquid, until a potential fire is detected, at which point the Halon 1301 is allowed to evaporate so as to form a gaseous fire suppressant that suppresses the fire.

For numerous reasons, it has become desirable to use inert gas as a fire suppressant instead of Halon 1301. There are two main types of inert gas suppressant systems. One of these systems stores the inert gas under pressure in one or more containers. However, because the inert gas must be stored as a compressed gas, rather than as a liquid, the volume of the one or more storage containers is relatively large.

Another type of inert gas suppressant system comprises a solid propellant gas generator for generating the inert gas when required. A typical solid propellant gas generator comprises pellets of solid propellant material (e.g. sodium azide), an ignitor, a gas exhaust and a filter. When the fire suppression system detects a potential fire, the ignitor in the gas generator is activated and generates heat. This initiates the combustion of the solid propellant material, thereby generating inert combustion gas and some particulate matter. The inert combustion gases exit the gas generator through the exhaust and pass into the area to be protected from fire. In contrast, the filter prevents the particulate matter from exiting the gas generator. As the solid propellant gas generator generates the inert gas when required, rather than storing compressed gas, its use enables the fire suppression system to be smaller and lighter. However, the pyrotechnic reaction that generates the gas also generates a large amount of heat, which is undesirable. Typically, cooling systems are employed to cool the combustion gases produced, but this adds further weight, size and complexity to the system, rendering gas generators less attractive.

Furthermore, both types of inert gas fire suppression systems described above present a safety hazard to personnel entering the protected space after discharge of the inert gas, since the inert gas dilutes the oxygen in the protected space and the human body has no means of detecting low oxygen concentrations.

### SUMMARY

A first set of embodiments of the invention provides a solid propellant gas generator fire suppression device comprising: a solid propellant material for generating a first fire suppression gas when combusted; an ignitor for igniting the solid propellant material so as to generate said gas; an exhaust for said gas; and an odorizer material arranged within the gas generator so that when the ignitor is activated the odorizer material, or an odorous product thereof, exits the gas generator through the exhaust.

The fire suppression gas may be an inert gas, such as nitrogen.

Less desirably, the fire suppression gas may be a chemically active gas for extinguishing a fire.

The ignitor may comprise an electrically activated ignitor and/or an explosive charge.

The gas generator may be part of a fire protection system comprising a smoke and/or heat detector coupled to said ignitor and configured such that when said detector detects smoke and/or heat the ignitor is activated so as to ignite the solid propellant material. Alternatively, or additionally, to comprising a smoke and/or heat detector, the system may comprise a flame detector and/or gas detector coupled to said ignitor and configured such that when said detector detects a flame and/or gas the ignitor is activated so as to ignite the solid propellant material.

The exhaust may comprise at least one pair of exhaust nozzles or vents, wherein each pair comprises nozzles or vents on opposing sides of the exhaust such that when the gas exits the exhaust it generates substantially no net force on the exhaust.

The odorizer material may be mixed in with the solid propellant material.

The solid propellant material may be in pellet form.

The odorizer material may be solid, such as a powder.

The odorizer material may contain sulphur. Optionally, the odorizer material or odorous product may comprise sulphur dioxide or sulphides.

The odorizer material may be arranged within the gas generator such that, upon activation of the ignitor and/or combustion of the solid propellant material, the odorizer material reacts with another compound present in the generator so as to produce said odorous product.

The odorizer material may be arranged within the generator such that it, or said odorous product, becomes entrained in the gas as the gas travels towards the exit of the exhaust.

The odorizer material may be provided within a chamber inside the gas generator, optionally in a different chamber to the solid propellant material.

The gas generator may comprise a seal for preventing the odorizer material from leaving the gas generator or chamber until the ignitor is activated.

The seal may be a diaphragm or burst disc at the exit of the exhaust, which is overcome by the increase in gas pressure within the gas generator when the solid propellant is combusted.

Embodiments of the invention provide a fire suppression system comprising: the gas generator described herein; and a storage tank for storing a fire suppression material; wherein the exhaust of the gas generator is arranged within the storage tank.

The fire suppression material may be stored in the storage tank and may be a second fire suppression gas; optionally wherein the second fire suppression gas is the same gas as the first fire suppression gas.

Alternatively, the fire suppression material may be a different gas to the first fire suppression gas or may be a powder or foam.

The storage tank may comprise a valve for allowing fire suppressant to exit the tank when the pressure inside the tank is at or above a predetermined level.

According to a second set of embodiments, the odorizer material may not be arranged within the gas generator, but may be arranged within a chamber inside the storage tank.

Accordingly, a second set of embodiments provides a fire suppression system comprising: a storage tank for storing a fire suppression material; a chamber housing an odorizer material arranged within the storage tank; a solid propellant gas generator having an ignitor and an exhaust, wherein the exhaust is arranged within the storage tank.

The gas generator may comprise a solid propellant material for generating a first fire suppression gas when combusted. The ignitor is configured for igniting the solid propellant material so as to generate the gas. The exhaust exhausts the gas into the storage tank.

The chamber may be configured to contain and shield the odorizer material from the combustion of the solid propellant. This enables a wide range of odorizer materials to be used, since they need not be resilient to pyrotechnic reactions.

The chamber may comprise a seal for preventing the odorizer material leaving the chamber until the ignitor is activated.

The seal may be a diaphragm or membrane, which is ruptured by the increase in gas pressure or temperature caused by the gas generated when the solid propellant is combusted.

The exhaust may be configured to direct combustion gases from the gas generator exhaust onto and/or through the chamber, e.g. so as to release or drive the odorizer material from the chamber and into the storage tank.

The chamber may be attached to the outside of the gas generator, or the chamber may be spaced apart from the gas generator.

The fire suppression gas may be an inert gas, such as nitrogen. Less desirably, the fire suppression gas may be a chemically active gas for extinguishing a fire.

The ignitor may comprise an electrically activated ignitor and/or an explosive charge.

The system may comprise a smoke and/or heat detector coupled to said ignitor and configured such that when said detector detects smoke and/or heat the ignitor is activated so as to ignite the solid propellant material. Alternatively, or additionally, to comprising a smoke and/or heat detector, the system may comprise a flame detector and/or gas detector coupled to said ignitor and configured such that when said detector detects a flame and/or gas the ignitor is activated so as to ignite the solid propellant material.

The exhaust may comprise at least one pair of exhaust nozzles or vents, wherein each pair comprises nozzles or vents on opposing sides of the exhaust such that when the gas exits the exhaust it generates substantially no net force on the exhaust.

The odorizer material may be solid, such as a powder.

The odorizer material may contain sulphur. Optionally, the odorizer material or odorous product may comprise sulphur dioxide or sulphides.

The odorizer material may be arranged within the chamber such that it, or said odorous product, becomes entrained in the gas as the gas travels towards the exit of the exhaust.

The fire suppression material may be stored in the storage tank and may be a second fire suppression gas; optionally wherein the second fire suppression gas is the same gas as the first fire suppression gas. Alternatively, the fire suppression material may be a different gas to the first fire suppression gas or may be a powder or foam.

The storage tank may comprise a valve for allowing fire suppressant to exit the tank when the pressure inside the tank is at or above a predetermined level.

### BRIEF DESCRIPTION OF THE DRAWINGS

Various embodiments will now be described, by way of example only, and with reference to the accompanying drawings in which:

FIG. 1 shows a solid propellant gas generator fire suppression device according to an embodiment of the present invention;

FIG. 2 shows a solid propellant gas generator fire suppression device according to another embodiment of the present invention; and

FIG. 3 shows a solid propellant gas generator fire suppression device according to another embodiment of the present invention

### DETAILED DESCRIPTION

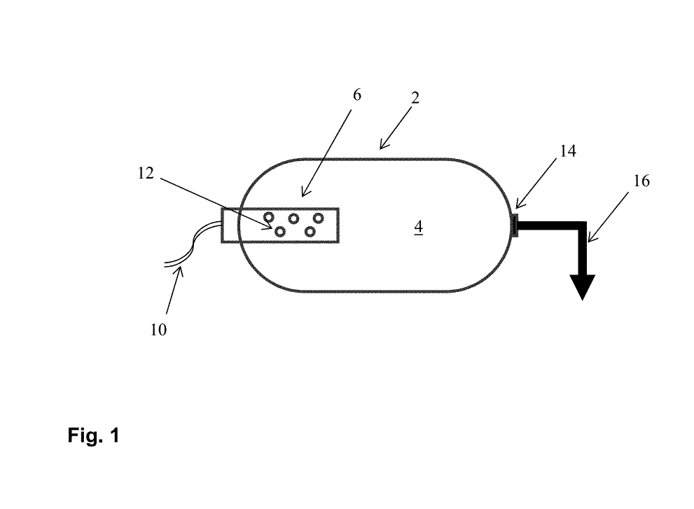

FIG. 1 shows a schematic of a portion of a fire suppression system according to an embodiment of the present invention. The system comprises a gas cylinder 2 that houses inert gas 4, such as nitrogen, for use in suppressing a fire. The cylinder 2 also houses a solid propellant gas generator 6 for use in generating an inert gas. The gas generator 6 comprises pellets of solid propellant material (e.g. sodium azide), an ignitor 10, gas exhaust vents or nozzles 12, and optionally a filter. The gas generator 6 also comprises an odorizer compound for providing a detectable odour to human personal when the system is discharged. The odorizer compound may be provided as a solid within the pellets of propellant material, or may be provided in the gas generator separate to the pellets. The cylinder 2 further comprises a burst disc 14 and discharge piping 16.

When the fire suppression system detects a potential fire, e.g. via a heat and/or smoke detector, the ignitor 10 in the gas generator 6 is activated and generates heat. This ignites the solid propellant material and initiates the combustion thereof, thereby generating inert combustion gas (and potentially also some particulate matter). The inert combustion gases exit the gas generator 6 through the exhaust vents or nozzles 12 in an exhaust and pass into the main body of the cylinder 2. The vents or nozzles 12 may be arranged so as to negate any net force on the exhaust caused by the flow of the gas. For example, the vents or nozzles 12 may be arranged in pairs on the exhaust, with one vent or nozzle of the pair on one side of the exhaust and another vent or nozzle of the pair on the opposing side of the exhaust. The vents or nozzles 12 may also be arranged so as to promote mixing of the gases exhausted from the gas generator 6 with the other gas initially stored in the main body of the cylinder 2. This serves to cool the hot gas exhausted from the gas generator 6. It will be appreciated that ratio of the quantity of gas generated by the gas generator 6 to the quantity of gas initially stored in the main body of the cylinder 2 may be selected during design of the system such that the mixed gas has the desired temperature when discharged.

If a filter is present in the gas generator 6 then this filter prevents particulate matter from exiting the gas generator 6 into the main body of the cylinder 2. The gas passing from the gas generator 6 into the main body of the cylinder 2 causes the gas pressure inside of the main body of the cylinder 2 to rise. The burst disc 14 is configured to seal the gas inside the main body of the cylinder 2 until that gas reaches a predetermined pressure. Once the gas inside the main body of the cylinder 2 has risen above this predetermined pressure, the gas overcomes the burst disc 14 and passes through the discharge piping 16 to the area to be protected from fire. The inert gas may then dilute the oxygen concentration in the area to be protected such that a fire in that area is suppressed or prevented from being established.

As mentioned above, the gas generator 6 also includes an odorizer compound. The odorizer compound is confined within the gas generator 6 until the ignitor 10 has been activated, at which point the odorizer compound may be converted from a solid phase (or less desirably a liquid phase) to a gaseous phase, or may react with another compound present in the gas generator 6 so as to generate another compound having a discernible smell. For example, the odorizer compound may be converted to the gaseous phase by the heat from the ignitor 10 or by the combustion of the solid propellant material. It is contemplated that the odorizer material may be a compound in solid form that is included within the solid propellant material, e.g. within a pellet of solid propellant material. For example, sulphur or its derivatives may be mixed in with the solid propellant material such that when the propellant material combusts, sulphur dioxide and/or sulphides (e.g. small volatile sulphides) are generated. Alternatively, it is contemplated that the odorizer compound may remain in a solid phase (or less desirably a liquid phase) during and after combustion of the solid propellant material, but may become entrained in the combustion gas as it flows towards and out of the exhaust.

The odorizer compound may be a compound that itself has a smell that is discernible to humans. Alternatively, the odorizer compound may be a compound that itself has no discernible smell, but that reacts with another compound present in the gas generator 6, upon activation of the ignitor 10, so as to generate another compound having a smell that is discernible to humans.

In the embodiments described above, activation of the ignitor 10 causes the odorizer compound itself, or a product thereof, to become entrained in the combustion gas that flows out of the exhaust vents or nozzles 12 and into the gas in the main body of the cylinder 2. As such, when the gas is discharged from the cylinder 2 into the area to be protected, the discharged gas will have an odor that is detectable to humans entering the area to be protected, even if the gas initially held within the main body of the cylinder 2 has no discernible smell (e.g. nitrogen). Personnel entering the area to be protected are therefore able to determine from the smell in that area that the fire suppression system has been discharged and that they are at risk from the low oxygen environment that is present.

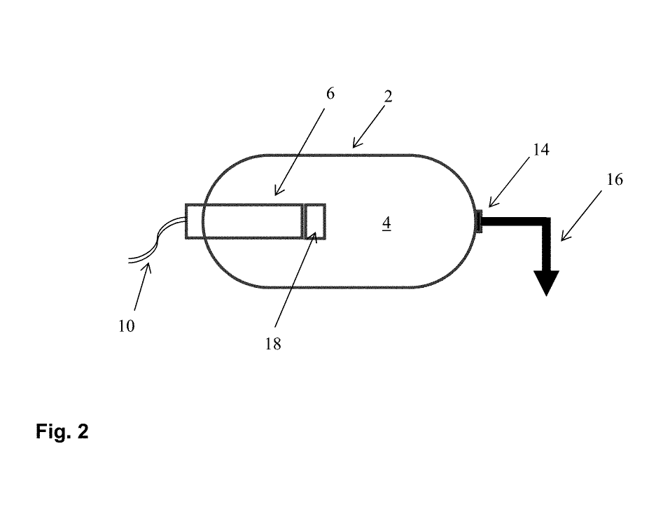

FIG. 2 shows a schematic of an embodiment that is substantially the same as that of FIG. 1, except that the odorizer compound is provided in a chamber 18 that is separate from the chamber of the gas generator 6 that includes the solid propellant. The separate chamber 18 enables the odorizer compound to be shielded from the combustion of the solid propellant. The chamber 18 may be within the gas generator housing or attached to the outside of it. In either case, the odorizer compound may be sealed inside of chamber 18 until the gas generator 6 is activated. Activation of the ignitor 10 causes the odorizer compound to be released from the chamber 18. This may be achieved by a number of means. For example, if the chamber 18 is sealed the ignitor 10 may be configured to rupture the seal when the ignitor 10 is triggered. This may occur directly, e.g. by the ignitor activating an explosive or piercing member that opens the seal of the chamber 18. Alternatively, or additionally, the combustion gases generated by ignition of the solid propellant material may cause an increase in pressure or temperature that may rupture the seal. Whether the chamber 18 is sealed or not, the apparatus may be configured such that the combustion gases pass through the chamber 18. For example, chamber 18 may be provided adjacent to vents or nozzles 12. The combustion gases may convert the odorizer compound from a solid phase (or less desirably a liquid phase) to a gaseous phase, or may cause the odorizer compound to react with another compound present so as to generate another compound having a discernible smell. For example, the odorizer compound may be converted to the gaseous phase by the heat from combustion gases. Alternatively, it is contemplated that the odorizer compound may remain in a solid phase (or less desirably liquid phase), but may become entrained in the combustion gas as it flows through and out of chamber 18. It is also contemplated that the odorizer compound may initially be in a gaseous phase in chamber 18, and activation of the ignitor 10 may release the gaseous material.

After activation of the ignitor, the odorizer compound is released or driven into the main body of the cylinder and the system proceeds to discharge as described in relation to FIG. 1.

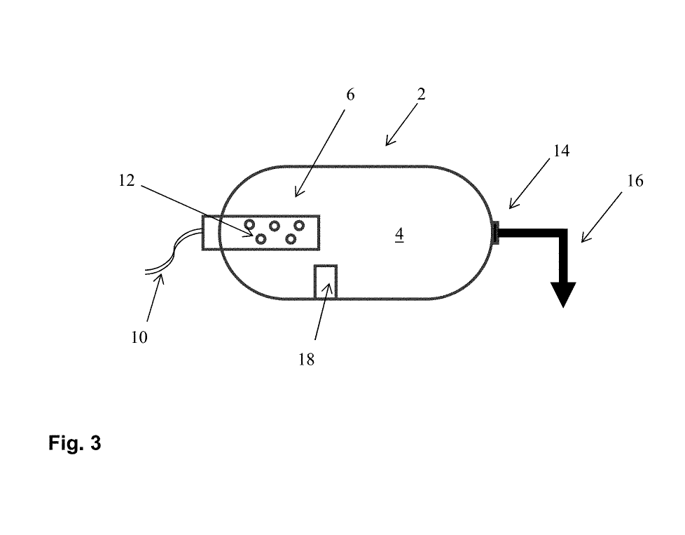

FIG. 3 shows a schematic of an embodiment that is substantially the same as that of FIG. 2, except that the chamber 18 is not part of or attached to gas generator 6. Rather, the chamber 18 is provided spaced apart from the gas generator in the main body of the cylinder 2. The odorizer material may be released from chamber 18 in any of the manners described in relation to FIG. 2.

The odorizer compound may be selected such that the compound, or product thereof, is a compound that is detectable by the human nose in concentrations of ppm or sub-ppm levels.

As described herein, the odorizer compound remains confined in the gas generator 6 or chamber 18 until the ignitor 10 has initiated, or only generates an odorous product when the ignitor 10 is initiated. This ensures that the odorizer compound or its odorous product do not enter the main body of the cylinder 2 until near to the time that gas is discharged into the area to be protected. As such, the odorizer compound or its odorous product are not stored in the main body of the cylinder 2 for long periods of time and hence do not leach into, or condense onto, the internal walls of the cylinder 2. The odorizer compound or its odorous product therefore remains fresh and pungent at the time of discharge, enabling less odorizer compound to be used in the system.

The odorizer compound, or the odourous product thereof, may be selected from a number of compounds. It will be appreciated that the odor of that compound should be sufficiently different from any odors that might normally occur within the area to be protected from fire. The compound may be a sulphur based chemicals such as thiols or mercaptans, sulfides or similar odorants. These are foul smelling “stench agents.” Other odorants that may be used include limonene, which has a pungent, sickly, orange smell.

The odorizer compound, or the odourous product thereof, may be an ester such as in the following table:

| Compound | Fragrance | Natural occurrence |
|---|---|---|
| Methyl formate | Ethereal | |
| Methyl acetate | Sweet, nail polish | |
| | Solvent | |
| Methyl butyrate | Fruity, apple, | |
| Methyl Butanoate | Pineapple | |
| Ethyl acetate | Sweet, solvent | Wine |
| Ethyl butyrate | Fruity, orange | |
| Ethyl butanoate | Pineapple | |
| Isoamyl acetate | Fruity, banana | |
| | Pear | |
| Pentyl butyrate | Fruity, pear | |
| Pentyl butanoate | Apricot | |
| Pentyl pentanoate | Fruity, apple | |
| Octyl acetate | Fruity, orange | |
| Fructone | Fruity, apple-like | |
| Hexyl acetate | Apple, floral, fruity | |
| Ethyl | strawberry | |
| methylphenylglycidate | | |

Alternatively, the odorizer compound, or the odourous product thereof, may be a terpene such as in the following table:

| Compound | Fragrance | Natural occurrence |
|---|---|---|
| Myrcene | Woody, complex | Verbena, bay |
| Geraniol | Rose, flowery | Geranium, lemon |
| Nerol | Sweet rose, flowery | Neroli, lemongrass |
| Citral, lemonal | Lemon | Lemon myrtle, |
| Geranial, neral | | lemongrass |
| Citronellal | Lemon | Lemongrass |
| Citronellol | Lemon | Lemongrass, rose |
| | | Pelargonium |
| Linalool | Floral, sweet | Coriander, sweet basil |
| | Woody, lavender | Lavender |
| Merolidol | Woody, fresh bark | Neroli, ginger |
| | | Jasmine |

Alternatively, the odorizer compound, or the odourous product thereof, may be a cyclic terpene such as in the following table:

| Compound | Fragrance | Natural occurrence |
|---|---|---|
| Limonene | Orange | Orange, lemon |
| Camphor | Camphor | Camphor laurel |
| Terpineol | Lilac | Lilac, cajuput |
| Alpha-lonone | Violet, woody | Violet |
| Thujone | Minty | Cypress, lilac, |
| | | Juniper |

Alternatively, the odorizer compound, or the odourous product thereof, may be an aromatic compound such as in the following table:

| Compound | Fragrance | Natural occurrence |
|---|---|---|
| Benzaldehyde | Almond | |
| Eugenol | Clove | Clove |
| Cinnamaldehyde | Cinnamon | Cassia, Cinnamon |
| Ethyl maltol | Cooked fruit | |
| | Caramelized sugar | |
| Vanillin | Vanilla | Vanilla |
| Anisole | Anise | Anise |
| Anethole | Anise | anise, Sweet basil |
| Estragole | Terragon | Terragon |
| Thymol | Thyme | Thyme |

Alternatively, the odorizer compound, or the odourous product thereof, may be an amine such as in the following table:

| Compound | Fragrance | Natural occurrence |
|---|---|---|
| Trimethylamine | Fishy, Ammonia | |
| Putrescine | Rotting flesh | Rotting flesh |
| Diaminobutane | | |
| Cadaverine | Rotting flesh | Rotting flesh |
| Pyridine | Fishy | |
| Indole | Faecal, flowery | Faeces jasmine |
| Skatole | Faecal | Faeces |

Alternatively, the odorizer compound, or the odourous product thereof, may be an alcohol such as in the following table:

| | | |
|---|---|---|
| Compound | Fragrance | Natural occurrence |

| | |
|---|---|
| Furaneol | strawberry |
| 1-Hexanol | herbaceous, |
| | woody |
| Cis-3-Hexen-1-ol | Fresh cut grass |
| Menthol | peppermint |

Alternatively, the odorizer compound, or the odourous product thereof, may be an aldehyde such as in the following table:

| | | |
|---|---|---|
| Compound | Fragrance | Natural occurrence |

| | |
|---|---|
| Acetaldehyde | ungent |
| Hexanol | Green, grassy |
| Cis-3-Hexen-1-ol | Green tomatoes |
| Furfural | Burnt oats |

Alternatively, the odorizer compound, or the odourous product thereof, may be a ketone such as in the following table:

| | | |
|---|---|---|
| Compound | Fragrance | Natural occurrence |

| | |
|---|---|
| Dihydrojasmone | Fruity, woody, |
| | floral |
| Oct-1-en-3-one | Blood, metallic, |
| | mushroom-like |
| 2-Acetyl-1-pyrroline | Fresh bread, |
| | jasmine rice |
| 6-Acetyl-2,3,4,,5- | Fresh bread, |
| tetrahydropyridine | tortillas, popcorn |

Alternatively, the odorizer compound, or the odourous product thereof, may be a lactone such as in the following table:

| Compound | Fragrance | Natural occurrence |
|---|---|---|
| Gamma- | Intense peach | |
| Decalactone | flavour | |
| Gamma- | Coconut odour, | Popular in suntan |
| Nonalactone | | lotions |
| Delta-Octalactone | Creamy note | |
| Jasmine lactone | Powerful fatty | |
| | fruity peach and | |
| | apricot | |
| Massoia lactone | Powerful creamy | |
| | coconut | |
| Wine lactone | sweet coconut odour | |
| Sotolon | Maple syrup, curry, | |
| | fenugreek | |

Alternatively, the odorizer compound, or the odourous product thereof, may be a thiol such as in the following table:

| | | |
|---|---|---|
| Compound | Fragrance | Natural occurrence |

| | |
|---|---|
| Furaneol | strawberry |
| 1-Hexanol | herbaceous, woody |
| Cis-3-Hexen-1-ol | Fresh cut grass |
| Menthol | peppermint |

Alternatively, the odorizer compound, or the odourous product thereof, may be a compound in the following table:

| Compound | Fragrance | Natural occurrence |
|---|---|---|
| Methylphospine & | Garlic-metallic | Two of the most |
| dimethylphosphine | | potent odorants known |
| Nerolin | | |
| Tetrahydrothiophene | | |
| 2,4,6-Trichloroanisole | | |
| Substituted | | |
| pyrazines | | |

The fire suppression system described herein may be used to protect any environment that personnel may enter from fire, such as a cargo compartment. The personnel would be educated that if they smell the odorizer compound, or the odourous product thereof, that the fire suppressant has been discharged and that they should exit the area.

A solid propellant gas generator fire suppression device is disclosed comprising: a solid propellant material for generating a first fire suppression gas when combusted; an ignitor for igniting the solid propellant material so as to generate said gas; an exhaust for said gas; and an odorizer material arranged within the gas generator so that when the ignitor is activated the odorizer material, or an odorous product thereof, exits the gas generator through the exhaust.

The use of an odorizer material enables personnel to determine via their sense of smell that the fire suppression system has been discharged, and that they are at risk from being in a low oxygen environment. The odorizer compound, or odorous product thereof, may only become entrained in the gas and exit the gas generator (or another chamber) after the ignitor has been activated. The odorizer compound or its odourous product may remain fresh and pungent at the time of discharge and relatively low amounts of odorizer compound may be used in the system. The ignitor or the combustion of the solid propellant material may assist in generating and/or dispersing the odorizer material, or product thereof, in the gas exhausted from the system.

Although it is known to use odorizer compounds in fire suppression systems, it is believed that it is not known to add them into a gas generator or confine them in a chamber that is opened by activating the gas generator. Rather, such compounds have been arranged downstream of an inert gas cylinder discharge point. Furthermore, systems in which an odorizer compound is stored in a gas storage tank suffer from the problem that the odorizer compound may leach or condense onto the wall of its storage tank over time. Further, although gas generators have been disclosed previously that use sodium azide and sulphur, the sulphur in these devices is included as an oxidant for capturing the sodium and not for forming odorous compounds. In these devices, the sulphur remains in solid form and does not exit the gas generator exhaust.

A fire suppression system is also disclosed herein comprising: the gas generator described herein; and a storage tank for storing a fire suppression material; wherein the exhaust of the gas generator is arranged within the storage tank.

Arranging the exhaust of the gas generator inside the storage tank may enable the fire suppression material in the storage tank to act as a cooling agent for cooling the hot gases exiting the exhaust of the gas generator. As such, thermal mixing may be achieved and also the hot exhaust of the gas generator may be hidden away within the storage tank, thus minimising thermal hazards typically associated with gas generators.

This arrangement also enables the ratio of the quantity of gas generated by the gas generator to the quantity of fire suppression material initially stored in the storage tank to be selected during design of the system such that the mixture has the desired temperature when discharged. In embodiments where the gas generated by the gas generator is different to the fire suppression material stored in the storage tank, this arrangement also enables the composition of the fire suppressant discharged from the overall system to be altered or selected by altering or selecting the ratio of the proportion of fire suppressant released from the gas generator to the proportion of fire suppressant initially stored in the storage tank.

Embodiments also enable the size of the system to be relatively low. For a given amount of fire suppressant to be discharged from the overall system, the combination of the storage tank and gas generator enables a smaller and lighter system than gas tanks alone.

Although the present invention has been described with reference to embodiments, it will be understood by those skilled in the art that various changes in form and detail may be made without departing from the scope of the invention as set forth in the accompanying claims.

1. A solid propellant gas generator fire suppression device comprising:
a solid propellant material for generating a first fire suppression gas when combusted;
an ignitor for igniting the solid propellant material so as to generate said gas;
an exhaust for said gas; and
an odorizer material arranged within the gas generator so that when the ignitor is activated the odorizer material, or an odorous product thereof, exits the gas generator through the exhaust.

2. The gas generator of claim 1, comprising a smoke and/or heat detector and/or flame detector and/or gas detector coupled to said ignitor and configured such that when said detector detects smoke and/or heat and/or flames and/or gas the ignitor is activated so as to ignite the solid propellant material.

3. The gas generator of claim 1, wherein the exhaust comprises at least one pair of exhaust nozzles or vents, wherein each pair comprises nozzles or vents on opposing sides of the exhaust such that when the gas exits the exhaust it generates substantially no net force on the exhaust.

4. The gas generator of claim 1, wherein the odorizer material is mixed in with the solid propellant material.

5. The gas generator of claim 1, wherein the odorizer material is solid, such as a powder.

6. The gas generator of claim 1, wherein the odorizer material contains sulphur;
optionally wherein the odorizer material or odorous product comprises sulphur dioxide or sulphides.

7. The gas generator of claim 1, wherein the odorizer material is arranged within the gas generator such that, upon activation of the ignitor and/or combustion of the solid propellant material, the odorizer material reacts with another compound present in the generator so as to produce said odorous product.

8. The gas generator of claim 1, wherein the odorizer material is arranged within the generator such that it, or said odorous product, becomes entrained in the gas as the gas travels towards the exit of the exhaust.

9. The gas generator of claim 1, wherein the odorizer material is provided within a chamber inside the gas generator, optionally in a different chamber to the solid propellant material.

10. The gas generator of claim 1, further comprising a seal for preventing the odorizer material from leaving the gas generator or chamber until the ignitor is activated.

11. A fire suppression system comprising:
a gas generator that includes:
a solid propellant material for generating a first fire suppression gas when combusted;
an ignitor for igniting the solid propellant material so as to generate said gas;
an exhaust for said gas; and
an odorizer material arranged within the gas generator so that when the ignitor is activated the odorizer material, or an odorous product thereof, exits the gas generator through the exhaust; and
a storage tank for storing a fire suppression material;
wherein the exhaust of the gas generator is arranged within the storage tank.

12. The fire suppression system of claim 11, wherein the storage tank comprises a valve for allowing fire suppressant to exit the tank when the pressure inside the tank is at or above a predetermined level.

13. A fire suppression system comprising:
a storage tank for storing a fire suppression material;
a chamber housing an odorizer material arranged within the storage tank;
a solid propellant gas generator having an ignitor and an exhaust, wherein the exhaust is arranged within the storage tank.

14. The system of claim 13, wherein the chamber comprises a seal for preventing the odorizer material leaving the chamber until the ignitor is activated.

15. The system of claim 13, wherein the exhaust is configured to direct combustion gases from the gas generator exhaust onto and/or through the chamber, e.g. so as to release or drive the odorizer material from the chamber and into the storage tank.
